(19) United States
(12) Patent Application Publication
(10) Pub. No.: US 2025/0346375 A1
(43) Pub. Date: Nov. 13, 2025

(54) ADAPTIVE ROTARY WING AIR VEHICLE NAVIGATION LIGHT SYSTEM

(71) Applicant: HONEYWELL INTERNATIONAL INC., Charlotte, NC (US)

(72) Inventors: Karthikeyan M, Madurai (IN); Gobinathan Baladhandapani, Madurai (IN); Ari Narayanan M, Madurai (IN)

(73) Assignee: HONEYWELL INTERNATIONAL INC., Charlotte, NC (US)

(21) Appl. No.: 18/796,962

(22) Filed: Aug. 7, 2024

(30) Foreign Application Priority Data
May 8, 2024 (IN) 202411036443

(51) Int. Cl. B64U 20/70; B64U 10/14

(52) U.S. Cl. CPC B64U 20/70; B64U 10/14

(57) ABSTRACT

An adaptive navigation light system is provided for a rotary wing air vehicle having at least a main body and a plurality of arms, where the main body includes a front end and a tail end disposed opposite the front end, and each arm of the plurality of arms extends from the main body. The adaptive navigation light system includes a plurality of circular light arrays and a processing system. Each circular light array is operable to emit light of a plurality of different colors, and each circular light array includes a plurality of individual light sources. The processing system is configured to track error data to determine which one of the different colors each circular light array should emit, determine which of the individual light sources in each in each circular light array should be energized, and energize the individual light sources that are determined should be energized.

### CROSS REFERENCE TO RELATED APPLICATION

The present application claims benefit of prior filed India Provisional Patent Application No. 202411036443, filed May 8, 2024, which is hereby incorporated by reference herein in its entirety.

### TECHNICAL FIELD

The present disclosure generally relates to rotary wing air vehicles and, more particularly, to an adaptive navigation light system of rotary wing air vehicles.

### BACKGROUND

All aircraft are required to have navigation lights. These lights allow an observer, such as a pilot in an aircraft, to determine the position and direction of another aircraft. To facilitate this capability, the navigation lights are color-coded based on location. Specifically, a green light is located on the right side of the aircraft, such as on the right wingtip, a red light located on the left side of the aircraft, such as on the left wingtip, and a white light is located on the tail end of the aircraft, facing backward (e.g., aft).

Although the navigation light configuration is fairly easy and straightforward to implement with fixed-wing aircraft, it can be much more challenging when it comes to rotary wing air vehicles, such as urban air mobility (UAM) and unmanned air vehicle (UAV) aircraft. This, at least in part, is because these vehicles have a higher degree of motional freedom. For example, these types of vehicles can reverse their flight direction without changing their heading direction. Thus, using fixed navigation lights on rotary wing vehicles has the potential to create confusion because, in certain situations, the navigation lights may not accurately indicate the true direction of flight to an observer. One potential solution to alleviate this confusion is to install different sets of navigation lights and activating the different sets of lights based on vehicle orientation. This potential solution is costly and adds undesirable weight to the vehicle.

Hence, there is a need for a navigation light system for rotary wing air vehicles that accurately indicates the true direction of flight and that is not costly and does not undesirably increase vehicle weight. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an adaptive navigation light system is provided for a rotary wing air vehicle having at least a main body and a plurality of arms, where the main body includes a front end and a tail end disposed opposite the front end, and each arm of the plurality of arms extends from the main body. The adaptive navigation light system includes a plurality of circular light arrays and a processing system. Each circular light array is operable to emit light of a plurality of different colors, and each circular light array includes a plurality of individual light sources. Each individual light source is operable, upon being energized, to emit light of one of the plurality of different colors. The plurality of circular light arrays includes at least (i) a front end light array that is adapted to be mounted on the front end, (ii) a tail end light array that is adapted to be mounted on the tail end, (iii) a plurality of arm light arrays, in which each arm light array is adapted to be mounted, one each, on a different one of the plurality of arms. The processing system is adapted to receive track error data representative of a track error of the rotary wing air vehicle. The processing system is configured to process the track error data to thereby (i) determine which one of the plurality of different colors each circular light array should emit, (ii) determine which of the individual light sources in each in each circular light array should be energized, and (iii) energize the individual light sources that are determined should be energized.

In another embodiment, a rotary wing air vehicle includes a main body, a plurality of arms, and an adaptive navigation light system. The main body includes a front end and a tail end disposed opposite the front end. Each arm of the plurality of arms extends from the main body. The adaptive navigation light system is coupled to the main body and includes a plurality of circular light arrays and a processing system. Each circular light array is operable to emit light of a plurality of different colors, and each circular light array includes a plurality of individual light sources. Each individual light source is operable, upon being energized, to emit light of one of the plurality of different colors. The plurality of circular light arrays includes at least (i) a front end light array that is adapted to be mounted on the front end, (ii) a tail end light array that is adapted to be mounted on the tail end, (iii) a plurality of arm light arrays, in which each arm light array is mounted, one each, on a different one of the plurality of arms. The processing system is adapted to receive track error data representative of a track error of the rotary wing air vehicle. The processing system is configured to process the track error data to thereby (i) determine which one of the plurality of different colors each circular light array should emit, (ii) determine which of the individual light sources in each in each circular light array should be energized, and (iii) energize the individual light sources that are determined should be energized.

In yet another embodiment, an adaptive navigation light system for a rotary wing air vehicle includes a rotary platform, a drive source, a plurality of light sources, and a processing system. The rotary platform is adapted to be rotationally mounted on the rotary wing air vehicle and is configured, upon receipt of a drive force, to rotate, about a rotational axis, to a commanded rotational position. The drive source is coupled to the rotary platform and is configured, upon being energized, to supply the drive force to the rotary platform to rotate the rotary platform to the commanded rotational position. The light sources are mounted on the rotary platform, and each light source is operable, upon being energized, to emit light of a predetermined color. The processing system is adapted to receive track error data representative of a track error of the rotary wing air vehicle. The processing system is configured to process the track error data to thereby determine the commanded rotational position of the rotary platform and energize the drive source to rotate the rotary platform to the commanded rotational position.

Furthermore, other desirable features and characteristics of the adaptive navigation light system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a top view of one example embodiment of a rotary wing air vehicle showing a functional block diagram of one embodiment of an adaptive navigation light system;

FIG. 2 depicts a functional block diagram of one example embodiment of a source of track error data that may be used with the adaptive navigation light system of FIG. 1;

FIGS. 3-11 depict simplified representations of the rotary wing air vehicle of FIG. 1 to provide illustrations of the functionality implemented by the adaptive navigation light system; and

FIG. 12 depicts a top view of one example embodiment of a rotary wing air vehicle showing a functional block diagram of another embodiment of an adaptive navigation light system.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

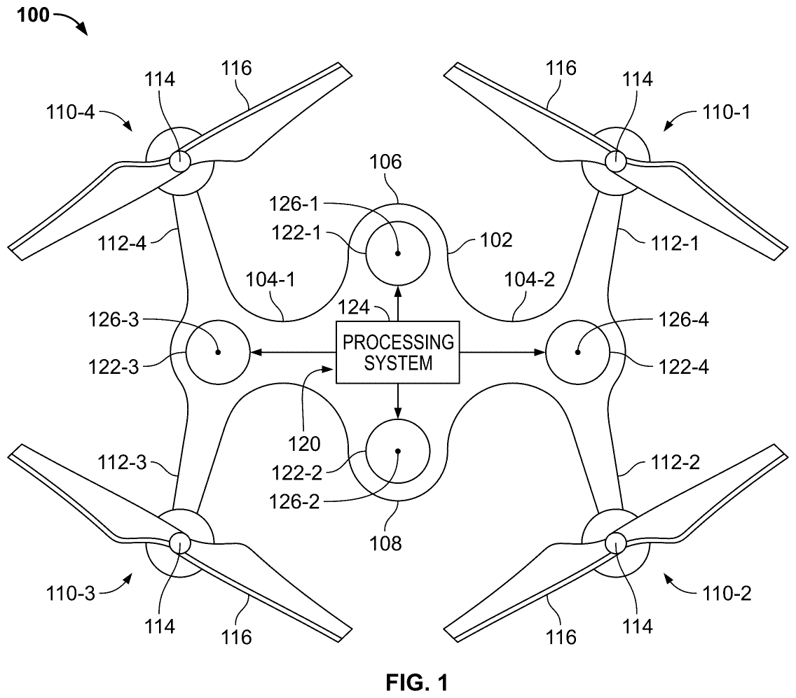

Referring to FIG. 1, a top view of one embodiment of a rotary wing air vehicle 100 is depicted and includes at least a main body 102 and a plurality of arms 104 (e.g., 104-1, 104-2). The main body 102 includes a front end 106 and a tail end 108 that is disposed opposite from the front end 106, and each of the arms 104 extends from the main body 102. Depending on the purpose of the rotary wing air vehicle, the main body 102 may be configured to carry various types of products and/or passengers.

Before proceeding further, it is noted that the depicted rotary wing air vehicle 100 is configured as a multi-copter. That is, it includes a plurality of rotors. In the depicted embodiment, the rotary wing air vehicle 100 includes four rotors 110 (110-1, 110-2, 110-3, 110-4), and each rotor 110 is rotationally mounted, one each, on a different rotor support 112 (112-1, 112-2, 112-3, 112-4). It will be appreciated that the rotary wing air vehicle 100 may be implemented with more or less than this number or rotors 110 and rotor supports 112. It will additionally be appreciated that the rotary wing air vehicle 100 may be implemented as an unmanned aerial vehicle (UAV), an urban air mobility (UAM) aircraft, or any one of numerous other types of rotary wing air vehicles. The rotary wing air vehicle 100 may be remotely controlled or fully autonomous.

Returning now to the description, it is noted that each of the rotors 110 includes at least a rotor hub 114 and a plurality of rotor blades 116. In the depicted embodiment, each rotor 110 includes two rotor blades 116, which may be implemented as individual rotor blades or formed as a single, integral element. It will be appreciated, of course, that the rotors 110 may be implemented with more than two rotor blades 116.

Regardless of the number of rotor blades 116, during operation of the rotary wing air vehicle, the rotors 110 are rotated to generate lift for the rotary wing air vehicle 100. The rotational speed of the rotors 110 is controlled via a flight control unit, and by varying the relative rotational speeds of the rotors 110, the rotary wing air vehicle 100 is maneuverable.

As FIG. 1 also schematically depicts, the rotary wing air vehicle 100 additionally includes an adaptive navigation light system 120. The adaptive navigation light system 120 includes a plurality of circular light arrays 122 and a processing system 124.

The circular light arrays 122 include at least a front end light array 122-1, a tail end light array 122-2, and a plurality of arm light arrays 122-3, 122-4. The front end light array 122-1 is mounted on the front end 106, the tail end light array 122-2 is mounted on the tail end 108, and each arm light array 122-3, 122-4 is mounted, one each, on a different one of the plurality of arms 104-1, 104-2, respectively. It will be appreciated that, although the depicted rotary wing air vehicle includes two arms-a left arm 104-2 and a right arm 104-2—and thus two arm light arrays—a left arm light array 122-3 and a right arm light array 122-4—the rotary wing air vehicle may, in other embodiments, include more than two arms 104-1, 104-2, and thus also include more than two arm light arrays 122-3, 122-4.

No matter the specific number of circular light arrays 122, each circular light array 122 is operable to emit light of a plurality of different colors. To do so, each circular light array 122 includes a plurality of individual light sources, each of which is operable, upon being energized, to emit light of one of the plurality of different colors. Although the plurality of different colors may vary, in one particular embodiment, the different colors include at least white, red, and green. It will be appreciated that the individual light sources may be implemented using light emitting diodes (LEDs), light-emitting electrochemical cells, electroluminescent components, lamps, or any other suitable light emitting devices, just to name a few. Preferably, however, each is implemented using LEDs.

The processing system 124 is coupled to receive track error data. The track error data is representative of the track error of the rotary wing air vehicle. As used herein, track error is the difference between the heading of the rotary wing air vehicle 100 and the flight path of the rotary wing air vehicle 100. The processing system 124 is configured to process the track error data to thereby determine which one of the different colors each circular light array 122 should emit, and to determine which of the individual light sources in each in each circular light array 122 should be energized. The processing system 124 then energizes (or causes to be energized) the individual light sources that it determines should be energized.

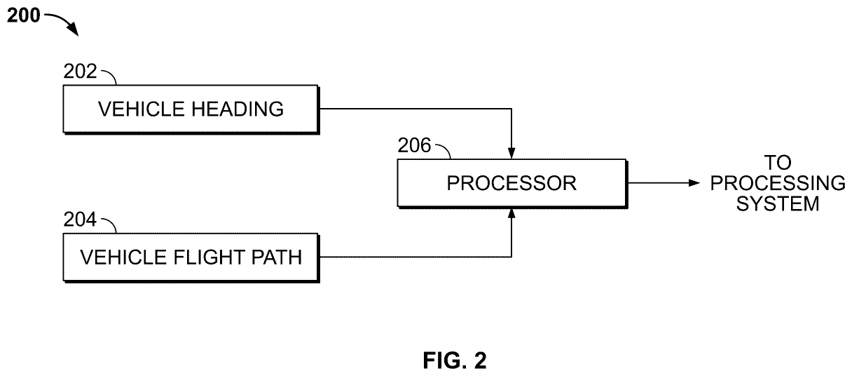

To implement the above functionality, and as depicted in FIG. 2, the source of track error data 200 includes at least a vehicle heading data source 202, a vehicle flight path data source 204, and a processor 206. The vehicle heading data source 202 is configured to determine that heading of the rotary wing aircraft 100 and to supply heading data representative thereof. The vehicle flight path data source 204 is configured to determine the flight path of the rotary wing air vehicle 100 and to supply flight path data representative thereof. The vehicle heading data source 202 and the vehicle flight path data source 204 may be implemented as separate data source systems or may be implemented as part of the same system, such as a flight management system (FMS).

Regardless of how the vehicle heading data source 202 and the vehicle flight path data source 204 are specifically implemented, the processor 206 is coupled to receive the heading data and the flight path data and is configured, upon receipt thereof, to determine the track error of the rotary wing air vehicle 100 and generate the track error data. The processor 206 then supplies the track error data to the processing system 124.

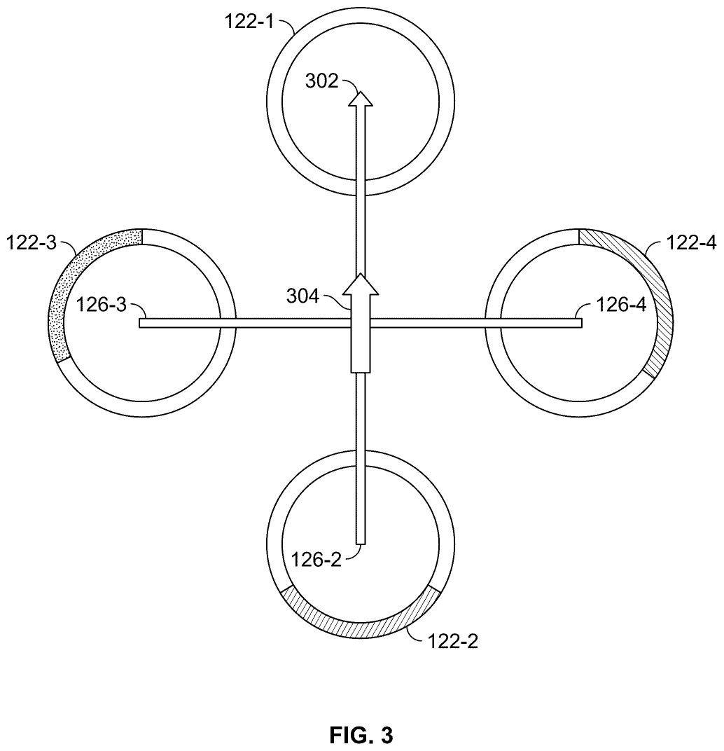

It is noted that the processing system 124 is additionally configured such that, upon energizing the individual light sources in each circular light array 122, the light that is emitted by each circular light array 122 will provide at least 110-degrees of illumination, and up to 140-degrees of illumination, about an axis that is perpendicular to flight path of the rotary wing aircraft 100. That is, the front end light array 122-1, when energized, will provide at least 110-degrees of illumination about a first axis 126-1, the tail end light array 122-2, when energized, will provide at least 110-degrees of illumination about a second axis 126-2, the left arm light array 122-3, when energized, will provide at least 110-degrees of illumination about a third axis 126-3, and the right arm light array 122-4, when energized, will provide at least 110-degrees of illumination about a fourth axis 126-1. This functionality is depicted in FIGS. 3-11 and will now be described.

In the example depicted in FIG. 3, the heading 302 and the flight path 304 of the rotary wing air vehicle 100 are the same, which means that the track error is zero. With this track error, the processing system 124, at least in the depicted embodiment, determines that the front end light array 122-1 should not emit any light, that the tail end light array 122-2 should emit white light, that the left arm array 122-3 should emit red light, and that the right arm array 122-4 should emit green light. As FIG. 3 also depicts, when the individual light sources are energized, the tail end light array 122-2 provides 140-degrees of illumination about the second axis 126-2, and the left and right arm arrays 122-3, 122-4 each provide 110-degrees of illumination about the third and fourth axes 126-3, 126-4, respectively.

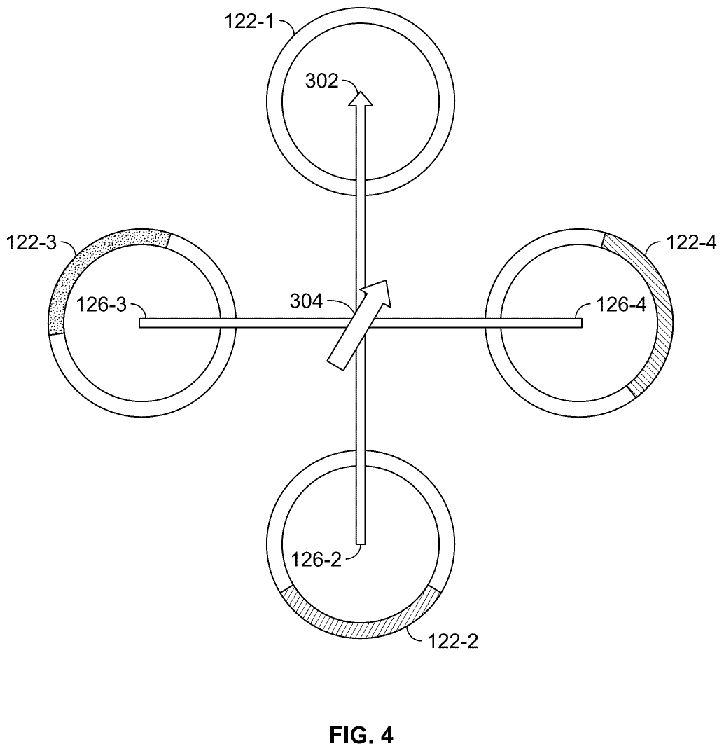

In the example depicted in FIG. 4, the heading 302 and the flight path 304 of the rotary wing air vehicle 100 are different, which means that the track error is non-zero. In this example, the magnitude of the track error is less than 45-degrees. With this track error, the processing system 124, at least in the depicted embodiment, again determines that the front end light array 122-1 should not emit any light, that the tail end light array 122-2 should emit white light, that the left arm array 122-3 should emit red light, and that the right arm array 122-4 should emit green light. Here too, and as FIG. 4 also depicts, when the individual light sources are energized, the tail end light array 122-2 provides 140-degrees of illumination about the second axis 126-2, and the left and right arm arrays 122-3, 122-4 each provide 110-degrees of illumination about the third and fourth axes 126-3, 126-4, respectively. However, the individual lights that are energized in each light array 122-2, 122-3, 122-4 to provide the 140-degrees and 110-degrees of illumination are rotationally shifted about the second, third, and fourth axes 126-2, 126-3, 126-4, respectively, to match the non-zero track error. So, for example, in the depicted embodiment, the track error is assumed to be +20-degrees. Thus, the individual lights that are energized in each light array 122-2, 122-3, 122-4 to provide the at least 110-degrees of illumination are rotationally shifted +20-degrees (e.g., clockwise) about the second, third, and fourth axes 126-2, 126-3, 126-4, respectively.

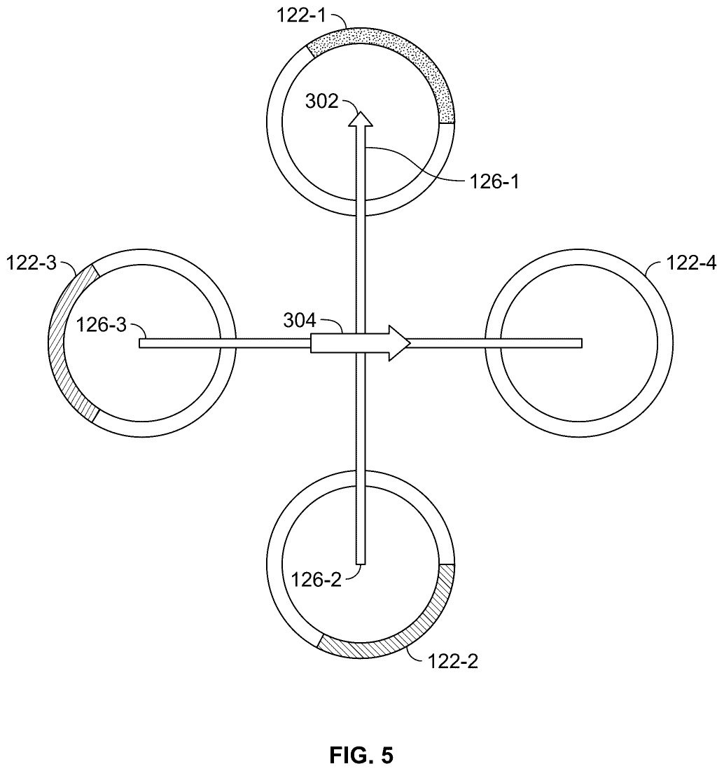

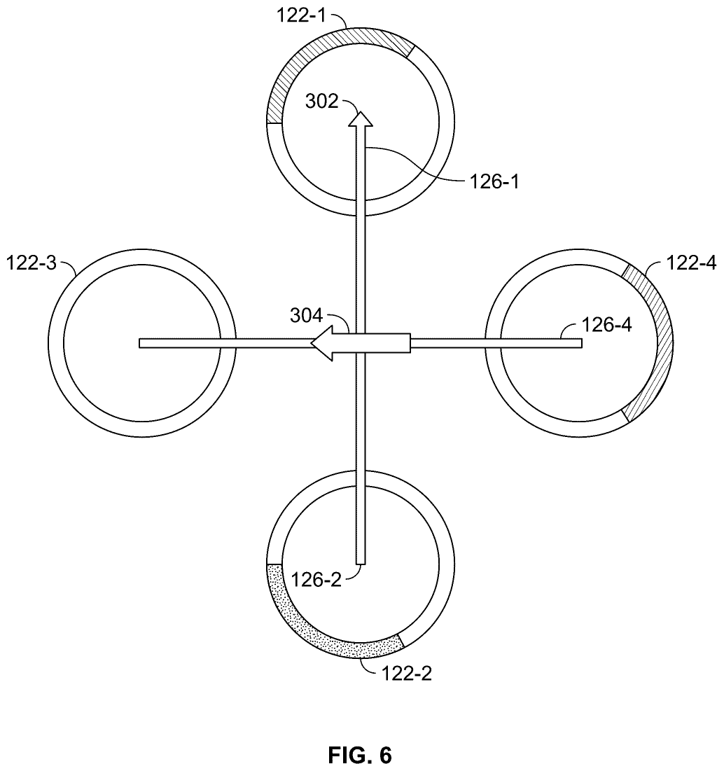

In the examples depicted in FIGS. 5 and 6, the heading 302 and the flight path 304 of the rotary wing air vehicle 100 are different, which means that the track error is non-zero. However, in these examples, the magnitude of the track error is 90-degrees. With this track error, the processing system 124, at least in the depicted embodiment, determines that the front end light array 122-1 should emit either a red light (FIG. 5) or a green light (FIG. 6), that the tail end light array 122-2 should emit either a green light (FIG. 5) or a red light (FIG. 6), that the left arm array 122-3 should either emit white light (FIG. 5) or not emit any light (FIG. 6), and that the right arm array 122-4 should either not emit any light (FIG. 5) or emit white light (FIG. 6). As FIGS. 5 and 6 also depict, the light arrays that emit green and red light provide 110-degrees of illumination and the light arrays that emit white light provide 140-degrees of illumination.

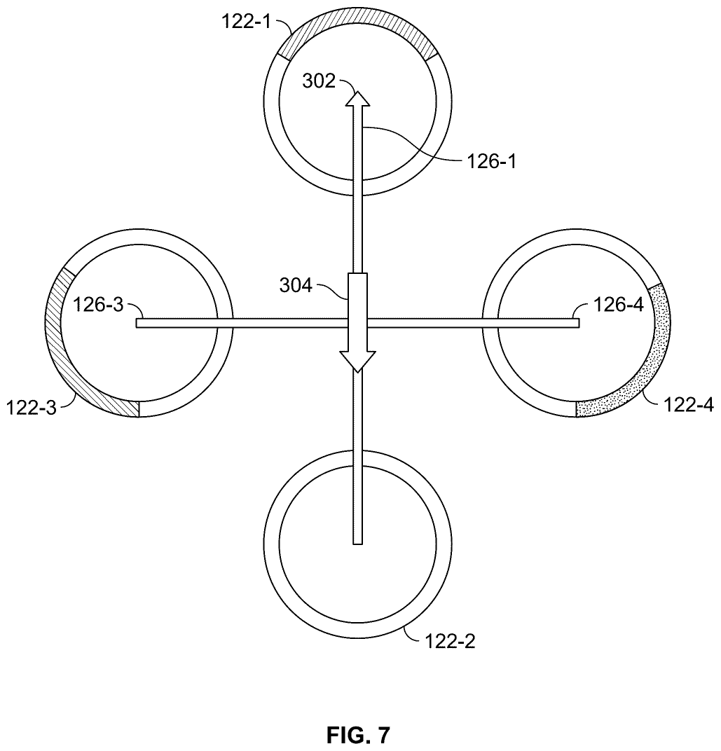

Turning to the example depicted in FIG. 7, in this example the heading 302 and the flight path 304 of the rotary wing air vehicle 100 are different, which means that the track error is non-zero. However, in this example, the magnitude of the track error is 180-degrees. With this track error, the processing system 124, at least in the depicted embodiment, determines that the front end light array 122-1 should emit white light, that the tail end light array 122-2 should not emit light, that the left arm array 122-3 should emit green light, and that the right arm array 122-4 should emit red light. As FIG. 7 also depicts, when the individual light sources are energized, the front end light array 122-1 provides 140-degrees of illumination about the first axis 126-1, and the left and right arm arrays 122-3, 122-4 each provide 110-degrees of illumination about the third and fourth axes 126-3, 126-4, respectively.

Before proceeding further it should be noted that, although not illustrated herein, for rotary wing air vehicle flight configurations in which the magnitude of the track error is greater than 135-degrees, but not equal to 180-degrees, the individual lights that are energized in each light array 122-1, 122-3, 122-4 to provide the 140-degrees and 110-degrees of illumination are rotationally shifted about the first, third, and fourth axes 126-2, 126-3, 126-4, respectively, to match the track error.

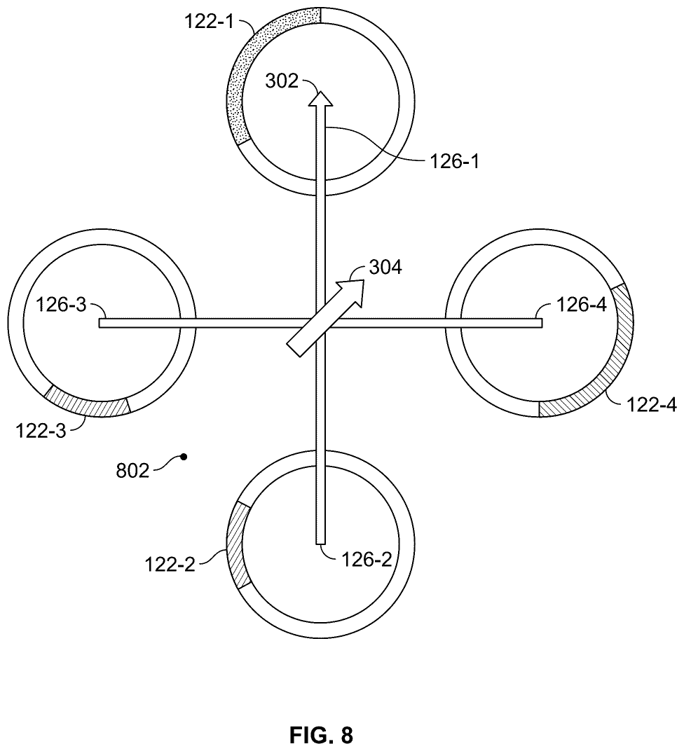

At certain predetermined track errors, such as track error magnitudes of 45-degrees and 135-degrees, the processing system 124 is configured such that, when the individual light sources of two adjacent circular light arrays 122 are energized, the light emitted by the adjacent circular light arrays 122 will provide at least 140-degrees of illumination about an axis that is perpendicular to, and disposed at a location behind a direction of, the flight path of the rotary wing aircraft. This functionality is depicted in FIGS. 8-11 and will now be described.

In the example depicted in FIG. 8, the track error is +45-degrees. With this track error, the processing system 124, at least in the depicted embodiment, determines that the front end light array 122-1 should emit red light, that the right arm light array 122-4 should emit green light, and that the tail end light array 122-2 and the left arm light array 122-3 should both emit white light. As FIG. 8 depicts, when the individual light sources are energized, the front end light array 122-1 and the right arm light array 122-4 each provide 110-degrees of illumination about the first and fourth axes 126-1, 126-4, respectively. However, the tail end light array 122-2 and the left arm light array 122-3 provide 140-degrees of illumination about axis 802.

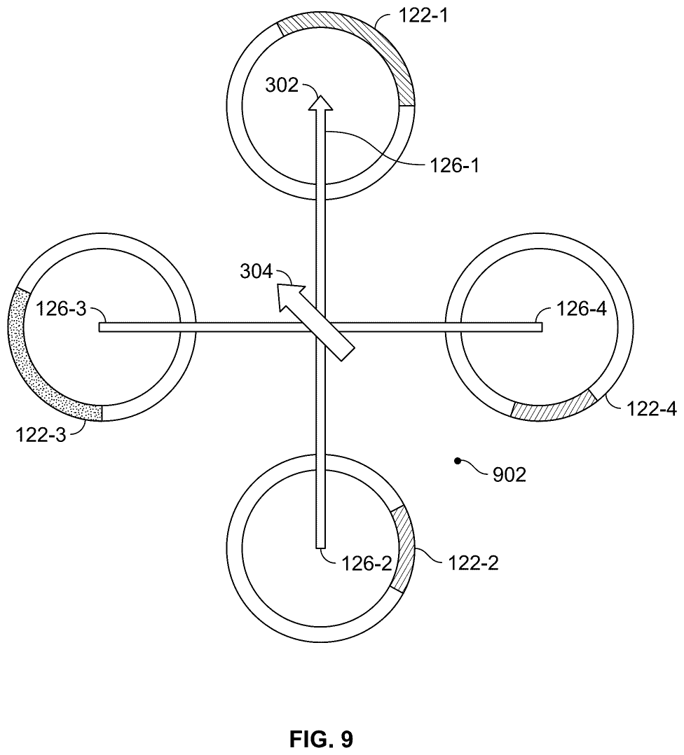

In the example depicted in FIG. 9, the track error is −45-degrees. With this track error, the processing system 124, at least in the depicted embodiment, determines that the front end light array 122-1 should emit green light, that the left arm light array 122-3 should emit red light, and that the tail end light array 122-2 and the right arm light array 122-4 should both emit white light. As FIG. 9 depicts, when the individual light sources are energized, the front end light array 122-1 and the left arm light array 122-3 each provide 110-degrees of illumination about the first and third axes 126-1, 126-3, respectively. However, the tail end light array 122-2 and the right arm light array 122-4 provide 140-degrees of illumination about axis 902.

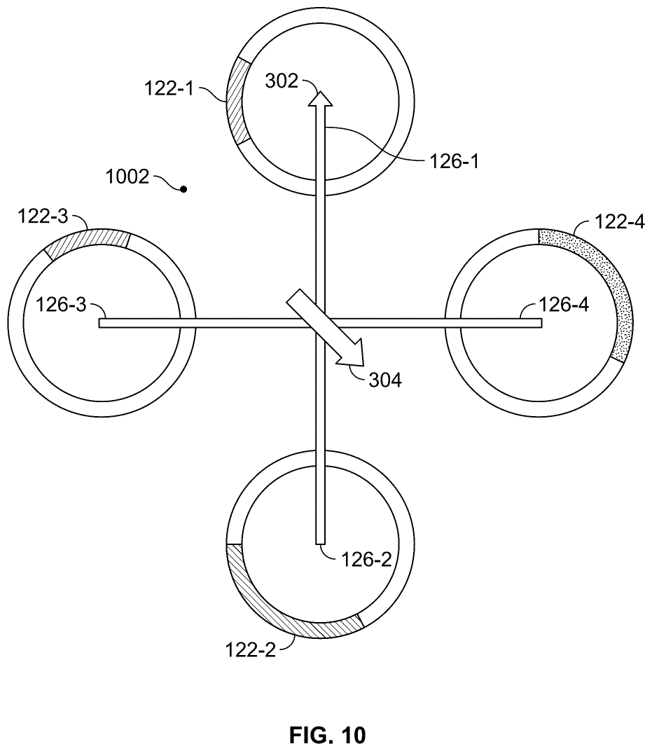

In the example depicted in FIG. 10, the track error is +135-degrees. With this track error, the processing system 124, at least in the depicted embodiment, determines that the right arm light array 122-4 should emit red light, that the tail end light array 122-2 should emit green light, and that the front end light array 122-1 and the left arm light array 122-3 should both emit white light. As FIG. 10 depicts, when the individual light sources are energized, the right arm light array 122-4 and the aft end light array 122-2 each provide 110-degrees of illumination about the fourth and second axes 126-3, 126-2, respectively. However, the front end light array 122-1 and the left arm light array 122-4 provide 140-degrees of illumination about axis 1002.

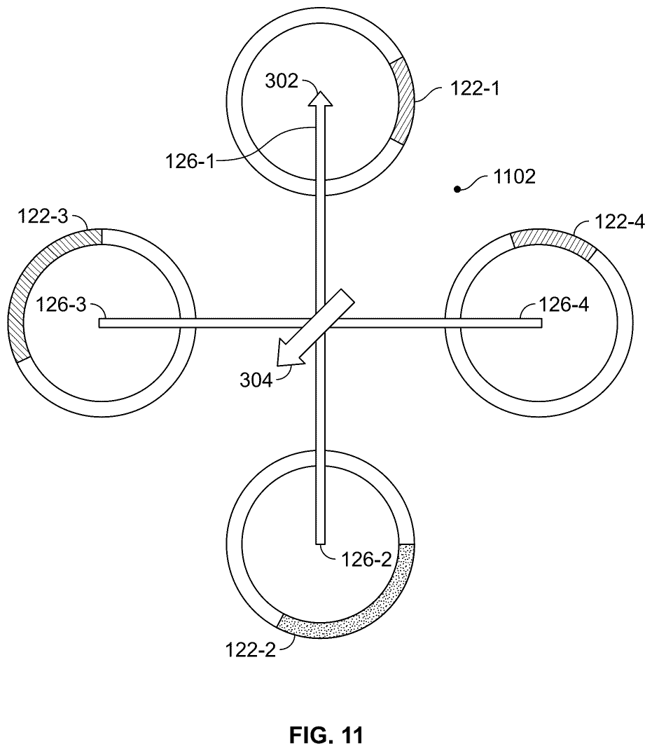

In the example depicted in FIG. 11, the track error is-135-degrees. With this track error, the processing system 124, at least in the depicted embodiment, determines that the left arm light array 122-3 should emit green light, that the tail end light array 122-2 should emit red light, and that the front end light array 122-1 and the right arm light array 122-4 should both emit white light. As FIG. 10 depicts, when the individual light sources are energized, the left arm light array 122-3 and the aft end light array 122-2 each provide 110-degrees of illumination about the third and second axes 126-3, 126-2, respectively. However, the front end light array 122-1 and the right arm light array 122-4 provide 140-degrees of illumination about axis 1102.

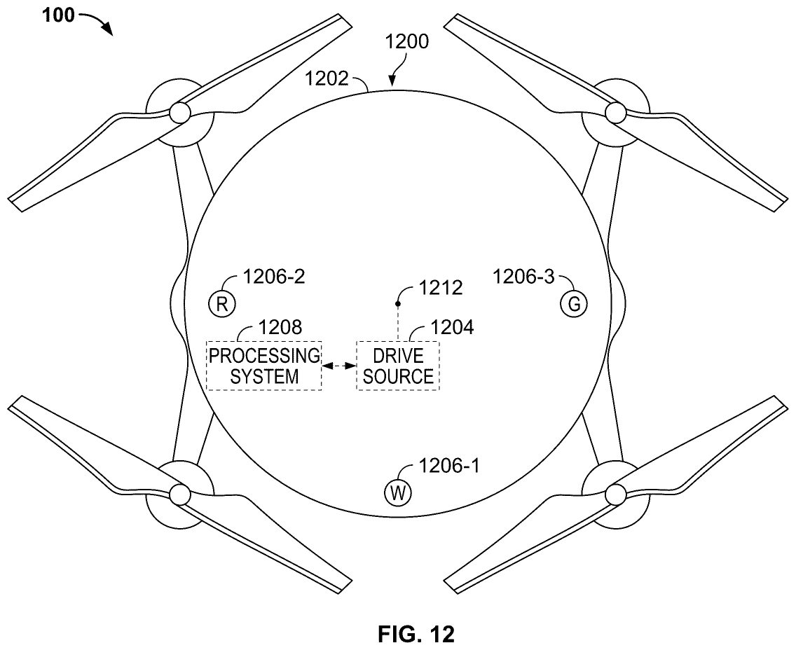

In the embodiments depicted and described thus far, the adaptive navigation light system 120 includes a plurality of circular light arrays 122 that are fixed relative to the main body 102 of the rotary wing air vehicle 100. In another embodiment, the adaptive navigation light system 120 instead includes light sources that are rotated relative to the main body of the rotary wing air vehicle 100. This embodiment is depicted in FIG. 12 and will now be described.

The adaptive navigation light system 1200 depicted in FIG. 12 includes a rotary platform 1202, a drive source 1204, a plurality of light sources 1206, and a processing system 1208. The rotary platform 1202 is rotationally mounted on the rotary wing air vehicle 100 and is configured, upon receipt of a drive force, to rotate, about a rotational axis 1212, to a commanded rotational position. Although the rotary platform 1202 depicted in FIG. 12 is circular, it will be appreciated that it could take on any one of numerous other shapes.

The drive source 1204 is coupled to the rotary platform 1202 and is configured, upon being energized, to supply the drive force to the rotary platform 1202 to thereby rotate the rotary platform 1202, about the rotational axis 1212, to the commanded rotational position. It will be appreciated that the drive source 1204 may be implemented using any one of numerous types of AC or DC motors.

The light sources 1206 are mounted on the rotary platform 1202. Each light source 1206 is operable, upon being energized (from a non-illustrated power source), to emit light of a predetermined color. In the depicted embodiment, there are three light sources-a first light source 1206-1, a second light source 1206-2, and a third light source 1206-3. The first light source 1206-1 is operable, upon being energized, to emit white light, the second light source 1206-2 is operable, upon being energized, to emit red light, and the third light source 1206-3 is operable, upon being energized, to emit green light. It will be appreciated that the light sources 1206 may be implemented using light emitting diodes (LEDs), light-emitting electrochemical cells, electroluminescent components, lamps, or any other suitable light emitting devices, just to name a few. Preferably, however, each is implemented using LEDs. It will additionally be appreciated that the first light source 1206-1 is preferably configured to provide at least 140-degrees of illumination, and that the second and third light sources 1206-2, 1206-3 are each preferably configured to provide at least 110-degrees of illumination.

As with the previously described embodiment, the processing system 1208 is coupled to receive track error data representative of the track error of the rotary wing air vehicle 100. The track error data source 200 is similar to the one described above and depicted in FIG. 2. In this embodiment, however, the processing system 1208 is configured to process the track error data to thereby determine the commanded rotational position of the rotary platform 1202 and to energize the drive source 1204 to rotate the rotary platform to the commanded rotational position. In this manner, the light sources 1206 are rotated, by the rotary platform 1202, to positions such that the first light source 1206-1 always emits white light in a direction opposite the flight path of the rotary wing air vehicle 100, the second light source 1206-2 always emits red light in the direction left of the flight path of the rotary wing air vehicle 100, and the third light source 1206-3 always emits green light in the direction right of the flight path of the rotary wing air vehicle 100.

The adaptive navigation light system disclosed herein accurately indicates the true direction of flight or a rotary wing air vehicle and is not costly and does not undesirably increase vehicle weight.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An adaptive navigation light system for a rotary wing air vehicle including at least a main body and a plurality of arms, the main body including a front end and a tail end disposed opposite the front end, each arm of the plurality of arms extending from the main body, the adaptive navigation light system comprising:
a plurality of circular light arrays, each circular light array operable to emit light of a plurality of different colors, each circular light array including a plurality of individual light sources, each individual light source operable, upon being energized, to emit light of one of the plurality of different colors, the plurality of circular light arrays including at least (i) a front end light array that is adapted to be mounted on the front end, (ii) a tail end light array that is adapted to be mounted on the tail end, (iii) a plurality of arm light arrays, each arm light array adapted to be mounted, one each, on a different one of the plurality of arms; and
a processing system adapted to receive track error data representative of a track error of the rotary wing air vehicle, the processing system configured to process the track error data to thereby (i) determine which one of the plurality of different colors each circular light array should emit, (ii) determine which of the individual light sources in each in each circular light array should be energized, and (iii) energize the individual light sources that are determined should be energized,
wherein the track error of the rotary wing air vehicle is a difference between heading and flight path of the rotary wing air vehicle.

2. The adaptive navigation light system of claim 1, wherein the plurality of different colors includes white, red, and green.

3. The adaptive navigation light system of claim 1, wherein, when the individual light sources in each circular light array are energized, the light emitted by each circular light array will provide at least 110-degrees of illumination about an axis that is perpendicular to flight path of the rotary wing aircraft.

4. The adaptive navigation light system of claim 1, wherein, for one or more predetermined track errors, when the individual light sources of two adjacent circular light arrays are energized, the light emitted by the adjacent circular light arrays will provide at least 140-degrees of illumination about an axis that is perpendicular to, and disposed at a location behind a direction of, the flight path of the rotary wing aircraft.

5. The adaptive navigation light system of claim 1, further comprising:
a track error data source configured to supply the track error data to the processing system.

6. The adaptive navigation light system of claim 5, wherein the track error data source comprises:
a vehicle heading data source configured to determine the heading of the rotary wing aircraft and supply heading data representative thereof;
a vehicle flight path data source configured to determine the flight path of the rotary wing air vehicle and supply flight path data representative thereof; and
a processor coupled to receive the heading data and the flight path data and configured, upon receipt thereof, to determine the track error of the rotary wing air vehicle and generate and supply the track error data.

7. A rotary wing air vehicle, comprising:
a main body including a front end and a tail end disposed opposite the front end;
a plurality of arms, each arm of the plurality of arms extending from the main body; and
an adaptive navigation light system coupled to the main body, the adaptive navigation light system comprising:
a plurality of circular light arrays, each circular light array operable to emit light of a plurality of different colors, each circular light array including a plurality of individual light sources, each individual light source operable, upon being energized, to emit light of one of the plurality of different colors, the plurality of circular light arrays including at least (i) a front end light array that is adapted to be mounted on the front end, (ii) a tail end light array that is adapted to be mounted on the tail end, (iii) a plurality of arm light arrays, each arm light array adapted mounted, one each, on a different one of the plurality of arms; and
a processing system adapted to receive track error data representative of a track error of the rotary wing air vehicle, the processing system configured to process the track error data to thereby (i) determine which one of the plurality of different colors each circular light array should emit, (ii) determine which of the individual light sources in each in each circular light array should be energized, and (iii) energize the individual light sources that are determined should be energized,
wherein the track error of the rotary wing air vehicle is a difference between heading and flight path of the rotary wing air vehicle.

8. The rotary wing air vehicle of claim 7, wherein the plurality of different colors includes white, red, and green.

9. The rotary wing air vehicle of claim 7, wherein, when the individual light sources in each circular light array are energized, the light emitted by each circular light array will provide at least 110-degrees of illumination about an axis that is perpendicular to flight path of the rotary wing aircraft.

10. The rotary wing air vehicle of claim 7, wherein, for one or more predetermined track errors, when the individual light sources of two adjacent circular light arrays are energized, the light emitted by the adjacent circular light arrays will provide at least 140-degrees of illumination about an axis that is perpendicular to, and disposed at a location behind a direction of, the flight path of the rotary wing aircraft.

11. The rotary wing air vehicle of claim 7, further comprising:
a track error data source coupled to the main body and configured to supply the track error data to the processing system.

12. The rotary wing air vehicle of claim 11, wherein the track error data source comprises:
a vehicle heading data source configured to determine the heading of the rotary wing aircraft and supply heading data representative thereof;
a vehicle flight path data source configured to determine the flight path of the rotary wing air vehicle and supply flight path data representative thereof; and
a processor coupled to receive the heading data and the flight path data and configured, upon receipt thereof, to determine the track error of the rotary wing air vehicle and generate and supply the track error data.

13. An adaptive navigation light system for a rotary wing air vehicle, comprising:
a rotary platform adapted to be rotationally mounted on the rotary wing air vehicle and configured, upon receipt of a drive force, to rotate, about a rotational axis, to a commanded rotational position;
a drive source coupled to the rotary platform and configured, upon being energized, to supply the drive force to the rotary platform to rotate the rotary platform to the commanded rotational position;
a plurality of light sources mounted on the rotary platform, each light source operable, upon being energized, to emit light of a predetermined color;
a processing system adapted to receive track error data representative of a track error of the rotary wing air vehicle, the processing system configured to process the track error data to thereby determine the commanded rotational position of the rotary platform and energize the drive source to rotate the rotary platform to the commanded rotational position,
wherein the track error of the rotary wing air vehicle is a difference between heading and flight path of the rotary wing air vehicle.

14. The adaptive navigation light system of claim 13, wherein:
The plurality of light sources includes at least a first light source, a second light source, and a third light source;
the first light source is operable, upon being energized, to emit white light;
the second light source is operable, upon being energized, to emit red light; and
the third light source is operable, upon being energized, to emit green light.

15. The adaptive navigation light system of claim 14, wherein:
the first light source is configured to provide at least 140-degrees of illumination; and
the second and third light sources are each configured to provide at least 110-degrees of illumination.

16. The adaptive navigation light system of claim 13, further comprising:
a track error data source configured to supply the track error data to the processing system.

17. The adaptive navigation light system of claim 16, wherein the track error data source comprises:
a vehicle heading data source configured to determine the heading of the rotary wing aircraft and supply heading data representative thereof;
a vehicle flight path data source configured to determine the flight path of the rotary wing air vehicle and supply flight path data representative thereof; and
a processor coupled to receive the heading data and the flight path data and configured, upon receipt thereof, to determine the track error of the rotary wing air vehicle and generate and supply the track error data.
